(19) United States
(12) Patent Application Publication
(10) Pub. No.: US 2017/0005325 A1
(43) Pub. Date: Jan. 5, 2017

(54) ANODE FOR A BATTERY CELL, METHOD FOR MANUFACTURING AN ANODE, AND BATTERY CELL

(71) Applicant: Robert Bosch GmbH, Stuttgart (DE)

(72) Inventors: Pallavi Verma, Leinfelden (DE); Andreas Gonser, Leinfelden-Echterdingen (DE)

(21) Appl. No.: 15/187,951

(22) Filed: Jun. 21, 2016

(30) Foreign Application Priority Data
Jun. 30, 2015 (DE) 102015212182.8

(51) Int. Cl. H01M 4/134; H01M 4/04; H01M 4/62; H01M 10/0525; H01M 4/38

(52) U.S. Cl. CPC H01M 4/134; H01M 10/0525; H01M 4/386; H01M 4/625; H01M 4/622; H01M 4/0409; H01M 2220/20; H01M 2004/027

(57) ABSTRACT

An anode for a battery cell, including an active material containing silicon, and a current collector to which the active material is applied, and an anode coating which is applied to the active material. The anode coating contains graphite and a binder. A method for manufacturing an anode, and a battery cell which includes at least one anode, are also described.

### CROSS REFERENCE

The present application claims the benefit under 35 U.S.C. §119 of German Patent Application No. DE 102015212182.8 filed on Jun. 30, 2015, which is expressly incorporated herein by reference in its entirety.

### FIELD

The present invention relates to an anode for a battery cell which includes a silicon-containing active material. Moreover, the present invention relates to a method for manufacturing an anode, and a battery cell which includes an anode according to the present invention.

### BACKGROUND INFORMATION

Electrical energy may be stored with the aid of batteries. Batteries convert chemical reaction energy into electrical energy. A distinction is made between primary batteries and secondary batteries. Primary batteries are non-rechargeable, while secondary batteries, also referred to as accumulators, are rechargeable. A battery includes one or multiple battery cells.

In particular, so-called lithium-ion battery cells are used in an accumulator. They are characterized, among other features, by high energy densities, thermal stability, and extremely low self-discharge. Lithium-ion battery cells are used, for example, in motor vehicles, in particular in electric vehicles (EVs), hybrid vehicles (HEVs), and plug-in hybrid vehicles (PHEVs).

Lithium-ion battery cells include a positive electrode, also referred to as a cathode, and a negative electrode, also referred to as an anode. The cathode and the anode each include a current collector, to which an active material is applied. The active material for the cathode is a lithium-metal oxide compound such as LiCoO₂ in particular. The active material for the anode is silicon, for example. However, graphite is also widely used as active material for anodes.

Lithium atoms are intercalated into the active material of the anode. During operation of the battery cell, i.e., during a discharging operation, electrons flow in an external circuit from the anode to the cathode. During a discharging operation, lithium ions migrate from the anode to the cathode within the battery cell. In the process, the lithium ions are reversibly deintercalated from the active material of the anode, also referred to as delithiation. During a charging operation of the battery cell, the lithium ions migrate from the cathode to the anode. In the process, the lithium ions are reversibly reintercalated into the active material of the anode, also referred to as lithiation.

The electrodes of the battery cell have a foil-like design and are wound to form an electrode winding, with a separator situated in between which electrically and mechanically separates the anode from the cathode. Such an electrode winding is also referred to as a “jelly roll.” The electrodes may also be layered one above the other to form an electrode stack. The electrodes and the separator are surrounded by an electrolyte which is generally liquid. The electrolyte is conductive for the lithium ions, and allows transport of the lithium ions between the electrodes.

Silicon, as the active material of the anode, has a higher storage capacity for lithium ions compared to graphite. However, the liquid electrolyte, together with the contained lithium, deposits on the surface of the active material and is thereby decomposed. In the process, a layer, referred to as a solid electrolyte interphase (SEI), forms. Lithium deposited at that location is no longer available for transporting lithium ions between the electrodes.

During operation of the battery cell, an anode with silicon as the active material experiences volume changes. Such a volume change may be as high as 300%. When lithium ions are intercalated the active material expands, and when lithium ions are deintercalated the active material contracts. Such volume changes may result in deformations of the active material and cracks, even chipping, in the SEI. As the result of further decomposition of the electrolyte, accompanied by further deposition of additional lithium, a new SEI is formed.

A generic battery cell which includes an anode and a cathode, in which the active material of the anode includes silicon, is described in German Patent Application No. DE 10 2012 212 299 A1, for example.

U.S. Patent Application Publication No. 2012/0231326 describes an anode for a battery cell which contains porous silicon and is provided with a coating. The coating is made of carbon, for example.

In addition, U.S. Patent Application Publication No. 2012/0100438 A1, German Patent Application No. DE 11 2012 001 289 T5, and U.S. Patent Application Publication No. 2013/0189575 A1 describe anodes made of porous silicon for battery cells, which are provided with a carbon coating.

### SUMMARY

An anode for a battery cell is provided. The anode includes an active material which contains silicon. The anode also includes a current collector to which the anodic active material is applied, and an anode coating which is applied to the anodic active material. The anodic active material is preferably designed as a monolith, and has a maximum thickness of 75 microns.

According to an example embodiment of the present invention, the anode coating applied to the anodic active material contains graphite and a binder. The anode coating may thus be applied to the anodic active material relatively easily, namely, in the form of a slip layer and preferably with the aid of a doctor knife.

In addition, the graphite contained in the anode coating acts as an active anode material, and may thus pick up lithium ions during charging of the battery cell.

In a first charging operation of the battery cell, a stable protective layer, referred to as a solid electrolyte interphase (SEI), forms, in particular on the anode coating. This protective layer, which is impermeable to electrolyte, prevents contact of electrolyte with the silicon of the anodic active material.

The anodic active material advantageously has porosity. The anodic active material is thus porous, and has pores. The maximum diameter of the pores of the anodic active material is preferably approximately 50 nanometers. Due to the porosity, during a charging operation the anodic active material is able to expand without destroying the protective layer.

The porosity is at least 20%, preferably between 60% and 80%, of the volume of the active material.

The binder in the anode coating preferably contains carboxymethylcellulose (CMC). The binder in the anode coating may also contain other substances, in particular styrene butadiene rubber (SBR), polyacrylic acid (PAA), lithium polyacrylic acid (LiPAA), alginic acid (alginate), and polyvinyl alcohol (PVA). Mixtures of such substances are also possible.

The anode coating contains binder in a proportion of between 2% and 20%. The proportion of binder is preferably 5% to 10%.

The remaining portion of the anode coating may include up to 100% graphite. However, it is also possible for the remaining portion of the anode coating to contain conductive carbon black in addition to graphite. The quantity ratio of the remaining portion of the anode coating is preferably between 100% graphite to 0% conductive carbon black and 75% graphite to 25% conductive carbon black.

According to one advantageous refinement of the present invention, an intermediate layer is situated between the current collector and the anodic active material. The intermediate layer forms a relatively good electrically conductive transition between the silicon of the anodic active material and the current collector.

The intermediate layer advantageously contains carbon black and a binder. An intermediate layer designed in this way increases the adhesion between the silicon of the anodic active material and the current collector.

The binder in the intermediate layer preferably contains carboxymethylcellulose (CMC). The binder in the intermediate layer may also contain other substances, in particular styrene butadiene rubber (SBR), polyacrylic acid (PAA), lithium polyacrylic acid (LiPAA), alginic acid (alginate), and polyvinyl alcohol (PVA). Mixtures of such substances are also possible.

The intermediate layer contains binder in a proportion of between 2% and 20%. The proportion of binder is preferably 5% to 10%.

Moreover, a method for manufacturing an anode according to the present invention is provided. An anode coating containing graphite and a binder, in the form of a slip layer, is doctored over an anodic active material containing silicon.

The anodic active material is preferably produced by initially creating a monolithic wafer. Porosity is subsequently introduced into the monolithic wafer by electrochemical etching, for example.

According to one advantageous refinement of the present invention, the anodic active material is applied to a current collector with the aid of an intermediate layer containing carbon black and a binder. The anodic active material is adhered to the current collector with the aid of the intermediate layer.

Moreover, a battery cell is provided which includes at least one anode according to the present invention.

A battery cell according to the present invention is advantageously used in an electric vehicle (EV), in a hybrid vehicle (HEV), in a plug-in hybrid vehicle (PHEV), or in a consumer electronic product. Consumer electronic products are understood in particular to mean mobile telephones, tablet PCs, or notebooks.

Due to the design according to the present invention of an anode, a stable protective layer, referred to as a solid electrolyte interphase (SEI), forms which prevents subsequent contact of electrolyte with the anodic active material. The overall volume of the monolithically designed anodic active material, including the contained pores, changes only insignificantly during a charging operation and during a discharging operation. Therefore, the anodic active material is able to expand during a charging operation without destroying the protective layer. Thus, no significant mechanical stresses develop between the anodic active material and the anode coating. In this way, cracks in the protective layer as well as chipping of the protective layer, with unavoidable deformation of the anodic active material, are still largely avoided during subsequent charging operations and discharging operations of the battery cell. The formation of the protective layer on the anode coating thus results in passivation of the anodic active material, which increases the cycle stability of the anode.

### BRIEF DESCRIPTION OF THE DRAWINGS

Specific embodiments of the present invention are explained in greater detail below with reference to the figures.

FIG. 1 shows a schematic representation of a battery cell.

FIG. 2 shows a schematic sectional representation of an anode directly after manufacture of the battery cell from FIG. 1.

FIG. 3 shows a schematic sectional representation of the anode from FIG. 2 during operation in the battery cell.

### DETAILED DESCRIPTION OF EXAMPLE EMBODIMENTS

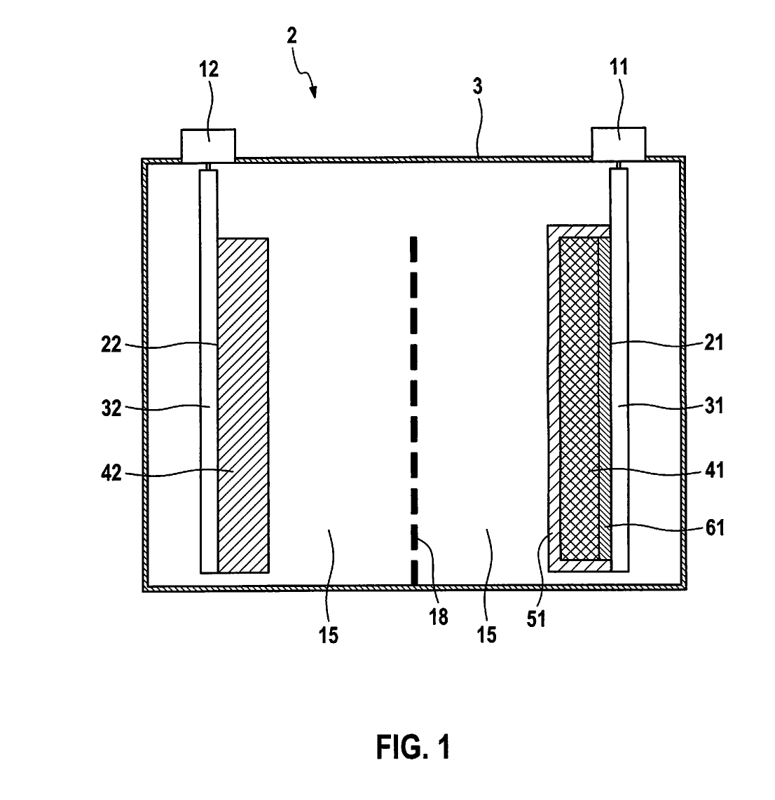

A battery cell 2 is schematically illustrated in FIG. 1. Battery cell 2 includes a cell housing 3 having a prismatic design, in the present case a cuboidal design. In the present case, cell housing 3 has an electrically conductive design and is made of aluminum, for example. However, cell housing 3 may also be made of an electrically insulating material, for example plastic.

Battery cell 2 includes a negative terminal 11 and a positive terminal 12. A voltage provided by battery cell 2 may be tapped via terminals 11, 12. In addition, battery cell 2 may also be charged via terminals 11, 12. Terminals 11, 12 are situated spaced apart from one another on a top surface of prismatic cell housing 3.

An electrode stack which includes two electrodes, namely, an anode 21 and a cathode 22, is situated within cell housing 3 of battery cell 2. Anode 21 and cathode 22 each have a foil-like design, and are stacked to form an electrode stack with a separator 18 situated in between. It is also possible to provide multiple electrode stacks in cell housing 3. An electrode winding, for example, may also be provided instead of the electrode stack.

Anode 21 includes a current collector 31, which has a foil-like design. Current collector 31 of anode 21 has an electrically conductive design and is made of a metal, for example copper. Current collector 31 of anode 21 is electrically connected to negative terminal 11 of battery cell 2.

Anode 21 also includes an anodic active material 41 which likewise has a foil-like design. Anodic active material 41 contains silicon as the base material. Anodic active material 41 is designed as a monolith. Anodic active material 41 has a maximum thickness of 75 microns. Anodic active material 41 also has a porous design, and has pores 55. The maximum diameter of pores 55 of anodic active material 41 is approximately 50 nanometers.

During the production of the anodic active material 41, for example a monolithic wafer is initially created. Porosity is subsequently introduced into the monolithic wafer by electrochemical etching, for example.

However, it is also conceivable to produce a monolithic layer of silicon with the aid of chemical vapor deposition (CVD) and to subsequently introduce porosity into this layer by electrochemical etching, for example. This method is particularly suited for producing relatively thin anodic active material 41, in particular in a thickness of less than one micron.

An intermediate layer 61 is situated between current collector 31 and anodic active material 41. In the present case, intermediate layer 61 of anode 21 includes carbon black and a binder. The binder in intermediate layer 61 contains carboxymethylcellulose (CMC). The binder in intermediate layer 61 may also contain other substances, in particular styrene butadiene rubber (SBR), polyacrylic acid (PAA), lithium polyacrylic acid (LiPAA), alginic acid (alginate), and polyvinyl alcohol (PVA). Mixtures of such substances are also conceivable.

Intermediate layer 61 of anode 21 is used for contacting anodic active material 41 with current collector 31. Intermediate layer 61 of anode 21 ensures relatively good adhesion of anodic active material 41 on current collector 31. In addition, intermediate layer 61 of anode 21 results in a relatively good electrically conductive transition between anodic active material 41 and current collector 31.

An anode coating 51 is applied to anodic active material 41. In the present case, anode coating 51 includes graphite and a binder. Conductive carbon black may also be contained in anode coating 51. The binder in anode coating 51 likewise contains carboxymethylcellulose (CMC). The binder in anode coating 51 may also contain other substances, in particular styrene butadiene rubber (SBR), polyacrylic acid (PAA), lithium polyacrylic acid (LiPAA), alginic acid (alginate), and polyvinyl alcohol (PVA). Mixtures of such substances are also possible.

Anode 21 has a layered design with multiple layers, and includes current collector 31, intermediate layer 61 situated thereon, anodic active material 41 situated on the intermediate layer, and anode coating 51 situated on the anodic active material. Anode coating 51 faces separator 18 of battery cell 2. Current collector 31 and anode coating 51 enclose anodic active material 41 and intermediate layer 61.

Cathode 22 includes a cathodic active material 42 which has a foil-like design. Cathodic active material 42 includes a lithium-metal oxide compound, for example lithium-cobalt oxide (LiCoO₂), as base material. Cathode 22 also includes a current collector 32, which likewise has a foil-like design. Cathodic active material 42 and current collector 32 are placed flatly against one another and joined together.

Current collector 32 of cathode 22 has an electrically conductive design and is made of a metal, for example aluminum. Current collector 32 of cathode 22 is electrically connected to positive terminal 12 of battery cell 2.

Anode 21 and cathode 22 are separated from one another by separator 18. Separator 18 likewise has a foil-like design. Separator 18 has an electrically insulating design, but is ionically conductive, i.e., is permeable for lithium ions 70.

Cell housing 3 of battery cell 2 is filled with a liquid electrolyte 15 or with a polymer electrolyte. Electrolyte 15 surrounds anode 21, cathode 22, and separator 18. Electrolyte 15 is also ionically conductive.

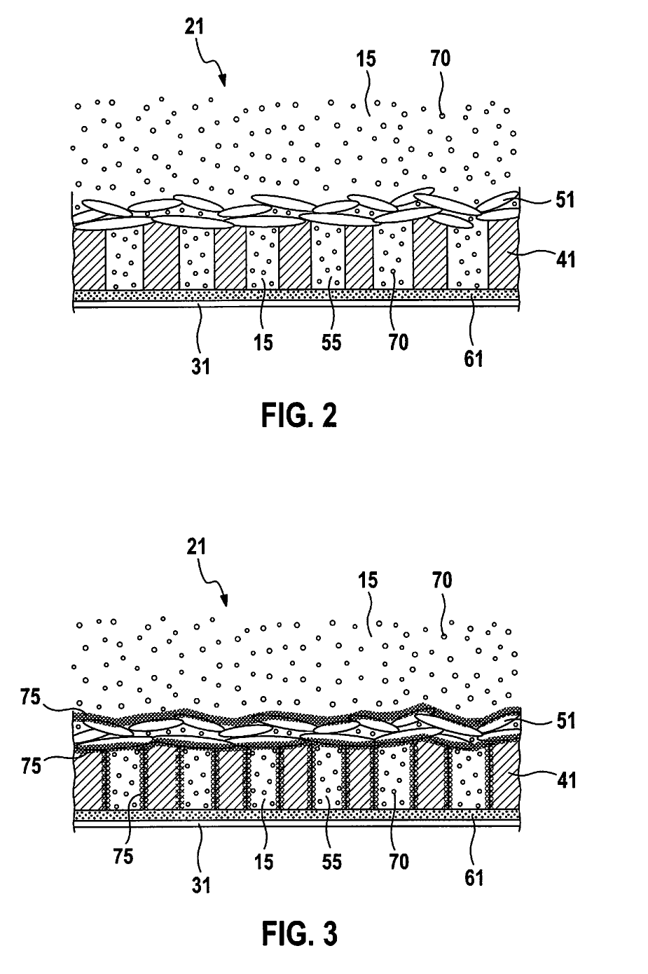

FIG. 2 shows a schematic sectional representation of anode 21 directly after manufacture of battery cell 2. This means that neither a charging operation nor a discharging operation of battery cell 2 has yet taken place.

Anode 21, as previously mentioned, has a layered design and includes current collector 31, intermediate layer 61 situated thereon, anodic active material 41 situated on the intermediate layer, and anode coating 51 situated on the anodic active material.

Electrolyte 15, which in the present case is liquid, surrounds anode 21. Electrolyte 15 contacts primarily anode coating 51. In addition, electrolyte 15 penetrates into pores 55 of anodic active material 41, and in the process contacts boundary surfaces of pores 55.

Free lithium ions 70 are present in electrolyte 15. Free lithium ions 70 are thus present on the surface of anode coating 51 facing away from anodic active material 41, and also in pores 55 of anodic active material 41.

In a subsequent charging operation of battery cell 2, lithium ions 70, which are still free, migrate to anode 21 and are intercalated into anodic active material 41, also referred to as lithiation. Lithium ions 70 are able to penetrate anode coating 51.

FIG. 3 shows a schematic sectional representation of anode 21 from FIG. 2 during operation in battery cell 2. This means that charging operations as well as discharging operations of battery cell 2 have already taken place.

Decomposition of liquid electrolyte 15 has taken place at the surface of anode coating 51, and liquid electrolyte 15 together with contained lithium ions 70 has deposited on the surface of anode coating 51. A protective layer 75, known as a solid electrolyte interphase (SEI), has thus formed on the surface of anode coating 51.

Decomposition of liquid electrolyte 15 has also taken place at the boundary surfaces of pores 55 of anodic active material 41. Liquid electrolyte 15 together with contained lithium ions 70 has hereby deposited on the boundary surfaces of pores 55 of anodic active material 41. A protective layer 75, known as a solid electrolyte interphase (SEI), has likewise formed on the boundary surfaces of pores 55 of anodic active material 41.

Resulting protective layer 75 is permeable to lithium ions 70. However, resulting protective layer 75 is impermeable to electrolyte 15. Further contact of electrolyte 15 with anode coating 51 and with anodic active material 41 is thus prevented.

In a subsequent charging operation of battery cell 2, free lithium ions 70 migrate to anode 21 and are intercalated into anodic active material 41. In the process, anodic active material 41 expands. Due to pores 55, sufficient free space is present for the expansion of anodic active material 41.

During intercalation of lithium ions 70, porous anodic active material 41 therefore expands predominantly in the direction of its pores 55. The diameter of pores 55 of anodic active material 41 thereby decreases. The change in the overall volume of monolithically designed anodic active material 41, including contained pores 55, is insignificant.

Thus, also no significant mechanical stresses develop between anodic active material 41 and anode coating 51 applied to anodic active material 41.

Cracks in protective layer 75 as well as chipping of protective layer 75 at the boundary surfaces of pores 55 of anodic active material 41 and at the surface of anode coating 51 are thus largely avoided. Protective layer 75 which is present is thus maintained during subsequent charging operations and discharging operations.

The present invention is not limited to the exemplary embodiments described here and the aspects highlighted therein. Rather, numerous modifications within the range set forth in the claims are possible which are within the scope of activities carried out by those skilled in the art.

What is claimed is:

1. An anode for a battery cell, comprising:
an active material containing silicon;
a current collector to which the active material is applied; and
an anode coating which is applied to the active material, wherein the anode coating contains graphite and a binder.

2. The anode as recited in claim 1, wherein the active material has porosity.

3. The anode as recited in claim 1, wherein the binder in the anode coating contains carboxymethylcellulose.

4. The anode as recited in claim 1, wherein the anode coating contains binder in a proportion of 5% to 10%.

5. The anode as recited in claim 1, wherein an intermediate layer is situated between the current collector and the active material.

6. The anode as recited in claim 5, wherein the intermediate layer contains carbon black and a binder.

7. The anode as recited in claim 6, wherein the binder in the intermediate layer contains carboxymethylcellulose.

8. The anode as recited in claim 6, wherein the intermediate layer contains binder material in a proportion of 5% to 10%.

9. A method for manufacturing an anode, comprising:
doctoring an anode coating containing graphite and a binder, in the form of a slip layer, over an anodic active material containing silicon.

10. The method as recited in claim 9, wherein the active material is applied to a current collector with the aid of an intermediate layer containing carbon black and a binder.

11. A battery cell which includes at least one anode, the anode including an active material containing silicon, a current collector to which the active material is applied, and an anode coating which is applied to the active material, wherein the anode coating contains graphite and a binder.

12. A vehicle including a battery cell, the battery cell including at least one anode, the anode including an active material containing silicon, a current collector to which the active material is applied, and an anode coating which is applied to the active material, wherein the anode coating contains graphite and a binder.

13. The vehicle as recited in claim 12, wherein the vehicle is an electric vehicle.

14. The vehicle as recited in claim 12, wherein the vehicle is a hybrid vehicle.

15. The vehicle as recited in claim 12, wherein the vehicle is a plug-in hybrid vehicle.

16. A consumer product including a battery cell, the battery cell including at least one anode, the anode including an active material containing silicon, a current collector to which the active material is applied, and an anode coating which is applied to the active material, wherein the anode coating contains graphite and a binder.
